(19) United States
(12) Patent Application Publication
(10) Pub. No.: US 2009/0272681 A1
(43) Pub. Date: Nov. 5, 2009

(54) RECYCLE WATER TREATMENT SYSTEM FOR CAR WASH

(75) Inventor: Qingmei LI, Beijing (CN)

Correspondence Address: YING CHEN;Chen Yoshimura LLP, 255 S. GRAND AVE., # 215, LOS ANGELES, CA, 90012, US

(73) Assignee: BEIJING NENGTUO HIGH TECHNOLOGY CO., LTD, Beijing (CN)

(21) Appl. No.: 12/120,498

(22) Filed: May 14, 2008

(30) Foreign Application Priority Data
Apr. 30, 2008 (CN) 200810105666.8

(51) Int. Cl. B03D 3/06; B01D 15/24; C02F 9/02; C02F 9/14; C02F 9/04

(52) U.S. Cl. 210/195.3; 210/202; 210/151; 210/195.1; 210/196; 210/257.1

(57) ABSTRACT

The present invention relates to a recycle water treatment system for car wash comprising principally a flocculating sedimentation tank, a flotation tank, a tank of aerobic biofilter, a secondary sedimentation tank and a storage tank that are connected in sequence, wherein a flocculent feeder is equipped at the top of the flocculating sedimentation tank; a flotation aerator is equipped at the bottom and a float scraper is equipped at the top of the flotation tank; and an aerobic filter is equipped at the middle and an aerator is equipped at the bottom of the tank of aerobic biofilter, the inlet pipe of the flocculating sedimentation tank being the inlet pipe of the system of the invention, and the outlet pipe of the storage tank being the outlet pipe of the system of the invention. Such a system is particularly applicable for small- and medium-sized car washes, because it's effective in practical operation and convenient in installation and maintenance due to compactness.

### BACKGROUND OF THE INVENTION

1. Field of the Invention

This invention relates to a recycle water treatment system for car wash.

2. Description of the Related Art

Car washing, as a major water-dependent business in urban zones, requires water-recycling processes. Such processes are required because they may both save water and reduce contamination. In view of the characteristics of car washing, the recycled water needs treatments in order to remove particles, oils and organisms therein. The prior art solutions, involving certain processes as sedimentation and oil skimming, are not as effective as desired.

### SUMMARY OF THE INVENTION

To overcome above shortcomings of the prior art, the invention provides a recycle water treatment system for car wash. Such a system is particularly applicable for a medium- and small-sized car wash business, because it's effective in practical operation and convenient in installation and maintenance due to compactness.

To achieve above objective, the solution of the invention is: a recycle water treatment system for car wash comprising a flocculating sedimentation tank, a flotation tank, a tank of aerobic biofilter, a secondary sedimentation tank and a storage tank that are connected in sequence, wherein a flocculent feeder is equipped at the top of the flocculating sedimentation tank; a flotation aerator is equipped at the bottom and a float scraper is equipped at the top of the flotation tank; wherein an aerobic filter is equipped at the middle and an aerator is equipped at the bottom of the tank of aerobic biofilter.

The general treatment flow path according to the invention is designed to be reasonable. The first is chemical sedimentation, to dramatically reduce the particles and contaminants composing BOD/COD. Then dissolved air flotation is used to separate oils and other suspended matter. The subsequent process is high-efficient biochemical purification in the tank of aerobic biofilter where resolvable organisms are decomposed. And after undergoing the secondary sedimentation, the contaminants in the water effluents are considerably reduced, so as to be suitable for car wash. The treated water may be stored in the storage tank for recycling use. The system of the invention, with its compact and effective structure, is easy to install and maintain and thus is particularly suitable for urban car washes. In addition, the wastewater after washing a car may be re-used, thus saving water and reducing pollution.

### BRIEF DESCRIPTION OF THE DRAWING

FIG. 1 is a schematic view of a system according to an embodiment of the present invention.

### DETAILED DESCRIPTION OF THE PREFERRED EMBODIMENTS

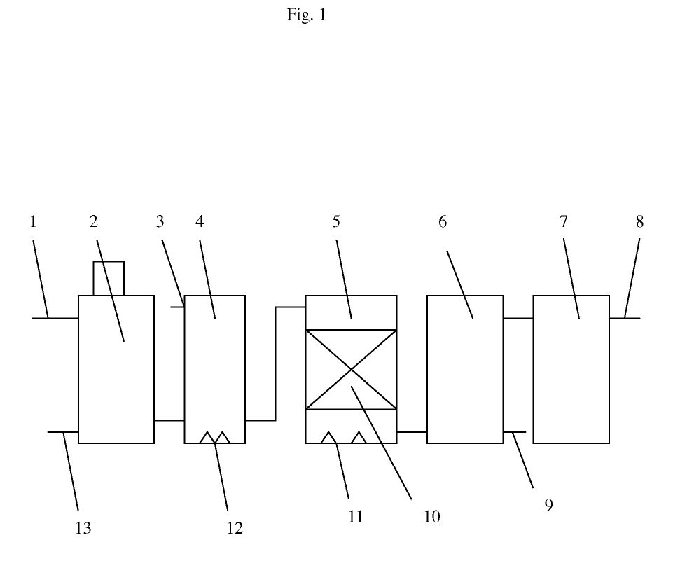

With reference to FIG. 1, the invention provides a recycle water treatment system for water wash comprising principally a flocculating sedimentation tank 2, a flotation tank 4, a tank of aerobic biofilter 5, a secondary sedimentation tank 6 and a storage tank 7 that are connected in sequence. A flocculent feeder is equipped at the top of the flocculating sedimentation tank. A flotation aerator 12 is equipped at the bottom and a float scraper is equipped at the top of the flotation tank. An aerobic filter 10 is equipped at the middle and an aerator 11 is equipped at the bottom of the tank of aerobic biofilter. The inlet pipe 1 of the flocculating sedimentation tank is the inlet pipe of the system. The outlet pipe 8 of the storage tank is the outlet pipe of the system.

The flocculating sedimentation tank may have an inner sedimentation structure in the form of sloping plates, and is equipped with a slope sedimentation zone. A distribution space with a blender is arranged in the front of the flocculating sedimentation tank, and the flocculent feeder is equipped above the distribution space. The feeder continuously distributes the flocculent into the distribution space according to the water flow. The blender mixes the flocculants into water completely to flocculate the organic particles and other organic molecules in the wastewater. The flocculants then flow to and settle in the slope sedimentation zone. Such a tank has high efficiency and compact size. And by adding the flocculants, 30% or more BOD and COD may be removed from wastewater with thick contaminants, thereby alleviating the burden of the subsequent biochemical processes.

A sludge exit 13 is located at the bottom of the flocculating sedimentation tank for discharging sludge under certain conditions. Also a submerged sludge pump may be equipped at the bottom of the flocculating sedimentation tank, for pumping out the sludge. Discharged or pumped out sludge may be concentrated in a sludge concentration tank, and then be filtered and compressed into cakes before arriving specialist disposal centers.

By means of Dissolved Air Flotation, the flotation tank may eliminate oils and other matter that may float up with bubbles after aeration. The flotation aerator at the bottom ejects air into the water. The air combines with the contaminants in the water into contaminant-carrying bubbles that float to the surface in the flotation tank. Accumulated floating contaminants up to a certain thickness may be gathered by a scraper to be discharge from a float exit 3.

The filter in the tank of aerobic biofilter may be a soft filter hanging in the tank, for high purification efficiency and simply clearing and maintenance. An aerator is equipped at the bottom of the tank of aerobic biofilter for providing air and oxygen for aerobic organisms. The Dissolved Air Flotation in the flotation tank also helps to enhance the oxygen content in the water.

The secondary sedimentation tank may have an inner sedimentation structure in the form of a sloping plate, and is equipped with a slope sedimentation zone for high sedimentation efficiency and small dimensions.

A sludge exit 9 may also be located at the bottom of the secondary sedimentation tank for discharging sludge under certain conditions. Also a submerged sludge pump may be equipped at the bottom of the secondary sedimentation tank, for pumping out the sludge. Discharged or pumped out sludge may be concentrated in a sludge concentration tank, and then be filtered and compressed into cakes before arriving specialist disposal centers.

When a submerged sludge pump is equipped at the bottom of each of the flocculating sedimentation tank and the secondary sedimentation tank, the exit pipe of each of the submerged sludge pumps is connected to a sludge concentration tank for subsequent concentration.

The exit pipe of the submerged sludge pump of the secondary sedimentation tank is further connected to the tank of aerobic biofilter through a sludge recycle pipe, so as to recycle sludge to improve the treatment of the tank of aerobic biofilter.

The secondary sedimentation tank includes a disinfecting apparatus for disinfecting the water in the secondary sedimentation tank. Thereby bacteria and other microorganisms are eliminated. One preferred type of disinfecting apparatus is an ozone generator, which kills bacteria and other microorganisms in the water by ozone dissolved therein.

All the connections between the tanks may be pipes with pumps and valves for flow control.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A recycle water treatment system for car wash, comprising a flocculating sedimentation tank, a flotation tank, a tank of aerobic biofilter, a secondary sedimentation tank and a storage tank connected in sequence.

2. The recycle water treatment system for car wash according to claim 1, wherein the flocculating sedimentation tank includes a flocculent feeder at its top.

3. The recycle water treatment system for car wash according to claim 2, wherein the flocculating sedimentation tank has an inner sedimentation structure in the form of sloping plates.

4. The recycle water treatment system for a car wash according to claim 1, wherein the flotation tank includes a flotation aerator at its bottom and a float scraper at its top.

5. The recycle water treatment system for car wash according to claim 1, wherein the tank of aerobic biofilter includes an aerobic filter at its middle and an aerator at its bottom.

6. The recycle water treatment system for car wash according to claim 5, wherein the aerobic filter is a soft filter suspended in the tank of aerobic biofilter.

7. The recycle water treatment system for car wash according to claim 1, wherein the secondary sedimentation tank has an inner sedimentation structure in the form of a sloping plate.

8. The recycle water treatment system for car wash according to claim 7, wherein the secondary sedimentation tank includes a disinfecting apparatus.

9. The recycle water treatment system for car wash according to claims 1, wherein each of the flocculating sedimentation tank and the secondary sedimentation tank includes a submerged sludge pump at its bottom, an exit pipe of each of the submerged sludge pumps being connected to a sludge concentration tank.

10. The recycle water treatment system for car wash according to claim 9, wherein the exit pipe of the submerged sludge pump of the secondary sedimentation tank is further connected to the tank of aerobic biofilter through a sludge recycle pipe.

11. The recycle water treatment system for car wash according to claim 1, wherein all connections between adjoining tanks are pipes with pumps and valves.

12. The recycle water treatment system for a car wash according to claim 3, wherein the flotation tank includes a flotation aerator at its bottom and a float scraper at its top.

13. The recycle water treatment system for car wash according to claim 12, wherein the tank of aerobic biofilter includes an aerobic filter at its middle and an aerator at its bottom.

14. The recycle water treatment system for car wash according to claim 13 wherein the aerobic filter is a soft filter suspended in the tank of aerobic biofilter.

15. The recycle water treatment system for car wash according to claim 14, wherein the secondary sedimentation tank has an inner sedimentation structure in the form of a sloping plate.

16. The recycle water treatment system for car wash according to claim 15, wherein the secondary sedimentation tank includes a disinfecting apparatus.

17. The recycle water treatment system for car wash according to claims 16, wherein each of the flocculating sedimentation tank and the secondary sedimentation tank includes a submerged sludge pump at its bottom of, an exit pipe of each of the submerged sludge pumps being connected to a sludge concentration tank.

18. The recycle water treatment system for car wash according to claim 17, wherein the exit pipe of the submerged sludge pump of the secondary sedimentation tank is further connected to the tank of aerobic biofilter through a sludge recycle pipe.

19. The recycle water treatment system for car wash according to claim 18, wherein all connections between adjoining tanks are pipes with pumps and valves.
